(19) United States
(12) Patent Application Publication
(10) Pub. No.: US 2012/0048897 A1
(43) Pub. Date: Mar. 1, 2012

(54) SPARE TIRE LIFT ASSIST APPARATUS

(76) Inventors: James Hugh Fowler, Novi, MI (US); Gary R. Fulkerson, White Lake, MI (US)

(21) Appl. No.: 12/871,413

(22) Filed: Aug. 30, 2010

(51) Int. Cl. B65D 85/06; B65D 65/04; B23P 11/00; B62D 43/00

(52) U.S. Cl. 224/42.2; 206/304.1; 29/426.1; 29/428

(57) ABSTRACT

A spare tire lift assist apparatus including a flexible container having a tire-receiving cavity. The flexible container includes a top wall and a bottom wall. First and second straps each are included and have a base portion that extends around and is fastened to the bottom wall and a strap handle proximate the top wall. The flexible container also includes a closable tire-receiving aperture.

### FIELD OF THE INVENTION

The present invention generally relates to a spare tire lift assist apparatus, and more particularly, to a flexible container for storing a spare tire and for aiding in the removal of the spare tire when necessary.

### BACKGROUND OF THE PRESENT INVENTION

Spare tires are frequently found in vehicles and are generally used when a vehicle tire has been damaged or otherwise needs to be removed from the vehicle. Spare tires are frequently stored in a variety of spare tire containment locations including spare tire wells in the trunk of a vehicle or below the vehicle. In most instances, the spare tire can become very dirty and is often difficult to remove from the spare tire containment location.

### SUMMARY OF THE PRESENT INVENTION

One aspect of the present invention includes a spare tire lift assist apparatus including a flexible container having a tire-receiving cavity. The flexible container includes a top wall and a bottom wall. First and second straps each are included and have a base portion that extends around and is fastened to the bottom wall and a strap handle proximate the top wall. The flexible container also includes a closable tire-receiving aperture.

Another aspect of the present invention includes a tire storage container having a smooth exterior including a top wall and a bottom wall. The space between the top wall and the bottom wall defines a tire-receiving cavity. At least one strap includes a base portion that is fastened to the bottom wall and a handle that is proximate the top wall. A closable tire-receiving aperture extends across the entire top wall.

Yet another aspect of the present invention includes a method for removing a spare tire from a vehicle trunk. The spare tire is placed in a flexible container having first and second circumferential lifting straps and a closable tire-receiving aperture. The flexible container is placed in a spare tire well disposed in the vehicle trunk. The flexible container is withdrawn from the spare tire well by raising the lifting straps. The spare tire is removed from the closable tire-receiving aperture.

Yet another aspect of the present invention includes a method for making a spare tire lift assist apparatus. A flexible container is formed having a top wall and a bottom wall. At least one strap is connected to the bottom wall of the flexible container. A handle is formed from the at least one strap proximate the top wall. An access aperture is formed in said spare tire lift assist apparatus. A tire is inserted into the access aperture.

These and other aspects, objects, and features of the present invention will be understood and appreciated by those skilled in the art upon studying the following specification, claims, and appended drawings.

### BRIEF DESCRIPTION OF THE DRAWINGS

FIG. 1 is a top perspective view of a vehicle incorporating one embodiment of a spare tire lift assist apparatus of the present invention;

FIG. 2 is an enlarged top perspective view of one embodiment of a spare tire lift assist apparatus disposed in a spare tire well in a truck of a vehicle;

FIG. 3 is a top perspective view of one embodiment of a spare tire lift assist apparatus of the present invention;

FIG. 3A is a top perspective view of another embodiment of a spare tire lift assist apparatus of the present invention;

FIG. 4 is a top plan view of the spare tire lift assist apparatus of FIG. 3;

FIG. 5 is a bottom plan view of the spare tire lift assist apparatus of FIG. 3;

FIG. 6 is a front elevational view of the spare tire lift assist apparatus of FIG. 3;

FIG. 7 is a side elevational view of the spare tire lift assist apparatus of FIG. 3;

FIG. 8 is a top perspective view of one embodiment of the spare tire lift assist apparatus with the tire-receiving aperture in an open position;

FIG. 9 is a top perspective view of the spare tire lift assist apparatus of FIG. 8 with the tire partially removed from the spare tire lift assist apparatus;

FIG. 10 is a top perspective view of the spare tire lift assist apparatus of FIG. 8 with the tire completely removed from the spare tire lift assist apparatus;

FIG. 11 is a side perspective view of a user carrying the spare tire lift assist apparatus using the strap handles;

FIG. 12 is a side perspective view of a user carrying the spare tire lift assist by a side handle; and

FIG. 13 is a side perspective view of a user transporting the spare tire lift assist by utilizing the roller wheels.

### DETAILED DESCRIPTION OF EMBODIMENTS

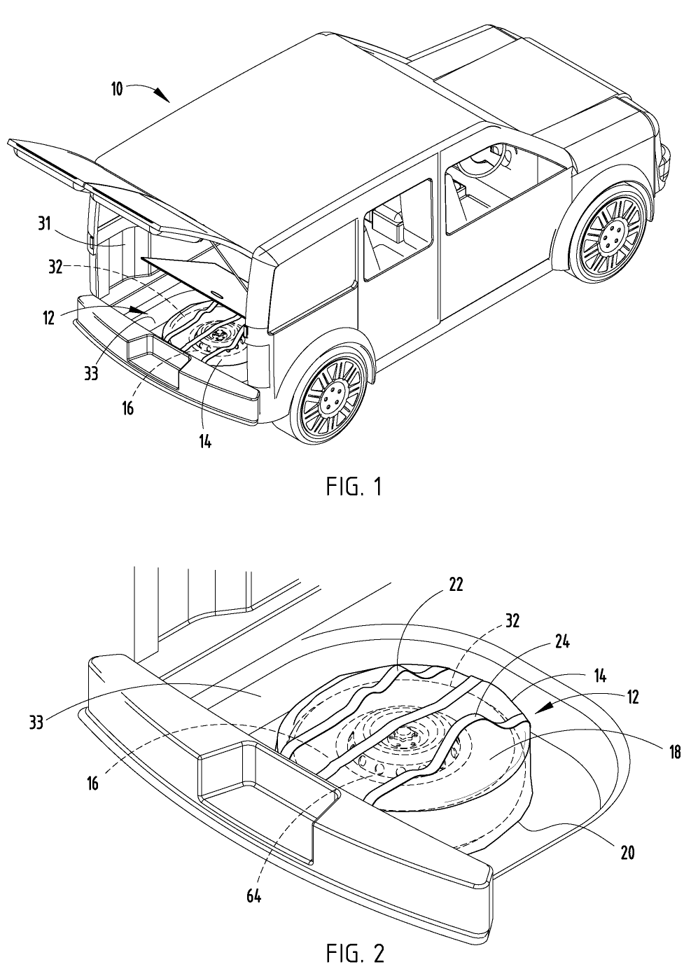

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring now to FIGS. 1-3, the reference numeral 10 generally designates a vehicle incorporating one embodiment of a spare tire lift assist apparatus 12 including a flexible container 14 having a tire-receiving cavity 16. The flexible container 14 includes a top wall 18 and a bottom wall 20. First and second straps 22, 24 each have a base portion 26 that extends around and is fastened to the bottom wall 20 and a strap handle 28 proximate the top wall 18. The flexible container 14 also includes a closable tire-receiving aperture 30.

Referring again to FIGS. 1-3, the flexible container 14 is generally cylinder-shaped and designed to receive a full-size spare tire 32. The top wall 18 and the bottom wall 20 are separated by a side wall 34 having a height slightly larger than the width of the spare tire 32. It is contemplated that the spare tire lift assist apparatus 12 may be of different sizes to accommodate spare tires 32 of varying sizes. The spare tire lift assist apparatus 12 is designed for use in a variety of vehicles 10 including sport utility vehicles, trucks, cars, and the like. It is contemplated that the spare tire lift assist apparatus 12 may be disposed below a trunk 31 of the vehicle 10 or within the trunk 31 of the vehicle 10 inside a spare tire well 33. The flexible container 14 of the spare tire lift assist apparatus 12 is generally constructed from a material having a very low co-efficient of friction relative to the spare tire 32 containment location. Stated differently, the material from which the flexible container 14 is made is very smooth and includes a low coefficient of friction when pulled over a plastic interior body part or painted exterior vehicle panel, thus helping a user remove the spare tire lift assist apparatus 12 and the spare tire 32 from the vehicle 10. For example, the material may be one of polypropylene, nylon, or the like.

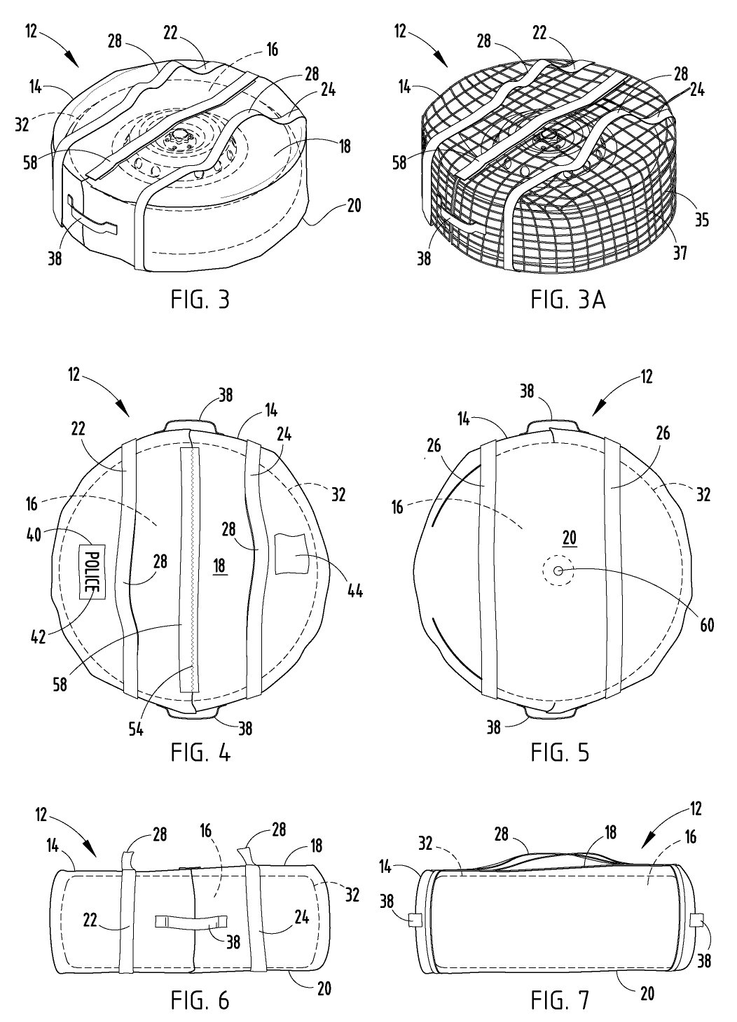

Referring now to FIG. 3A, in another embodiment of the present invention, the flexible container 14 is comprised of a plurality of woven or interconnected support lines 35 that define a plurality of spaces 37 therebetween. The support lines 35 of the flexible container 14 are formed of a flexible and smooth material that facilitates ease of removal of the spare tire 32 from the spare tire well 33. The support lines 35 may be made from a strong polymer such as polyethylene or polypropylene and may include an underlying reinforcement member such as a steel cable. It will be understood by one having ordinary skill in the art that many of the features discussed with respect to FIGS. 4-10 could also be applied to the embodiment illustrated in FIG. 3A.

Referring now to FIGS. 4-7, the base portion 26 of the first and second straps 22, 24 is secured with and extends under the bottom wall 20 of the flexible container 14. It is contemplated that the first and second straps 22, 24 may extend parallel to one another and parallel with the closable tire-receiving aperture 30, as will be discussed in further detail below. Alternatively, the straps 22, 24 may have a slight cant toward or away from one another. The base portion 26 of the first and second straps 22, 24 is connected with the bottom wall 20 of the flexible container 14 approximately one-third and two-thirds across the bottom wall 20 of the flexible container 14. It is contemplated that the location of the base portion 26 on the bottom wall 20 can vary to provide ease of removal of the spare tire 32 from the vehicle 10 when necessary. The first and second straps 22, 24 may be constructed from a highly reflective material or have a reflective material positioned on the first and second straps 22, 24. The reflective material may be disposed on the base portion 26 of the first and second straps 22, 24, on the strap handle 28 of the first and second straps 22, 24, or on both the base portion 26 and the strap handle 28.

As shown in the embodiments of FIG. 3 as well as FIG. 3A, one or more side handles 38 may be positioned on the side wall 34. The side handles 38 are arranged circumferentially on the flexible container 14 such that the spare tire 32 can be carried by a user in a luggage-type fashion. The side handles 38 are generally arranged proximate ends of the closable tire-receiving aperture 30 to minimize load forces on the closure mechanism (such as a hook and loop system or zipper system, disclosed in further detail below) that might otherwise occur if the handles 38 were placed elsewhere on the side wall 34.

Referring again to FIGS. 4-7, the first and second straps 22, 24 may be attached only to the bottom wall 20 of the flexible container 14. Alternatively, the first and second straps 22, 24 may be connected to the bottom wall 20 of the flexible container 14, as well as the sidewall 34, and possibly even a portion of the top wall 18. As shown in FIG. 4, the flexible container 14 may include a reflective portion 40 with identifying indicia 42. The reflective portion 40 may be formed from the flexible container 14, or may be a separate patch that is added to the flexible container 14 after the flexible container 14 is constructed. In addition, a storage pocket 44 may be disposed on the top wall 18 or the bottom wall 20 and may include tools for aiding in the removal of or securing of the spare tire 32. The storage pocket 44 may have a closable or open mouth that allows access to contents disposed therein. The identifying indicia 42 may be any of a variety of terms or phrases, such as the word “POLICE,” as shown in FIG. 4. Additionally, it is contemplated that the flexible container 14 may be constructed from a material that is safety orange or safety yellow in color. Accordingly, during a tire changing operation, the user can place the flexible container 14 in a location visible to traffic to indicate that a vehicle tire is being changed.

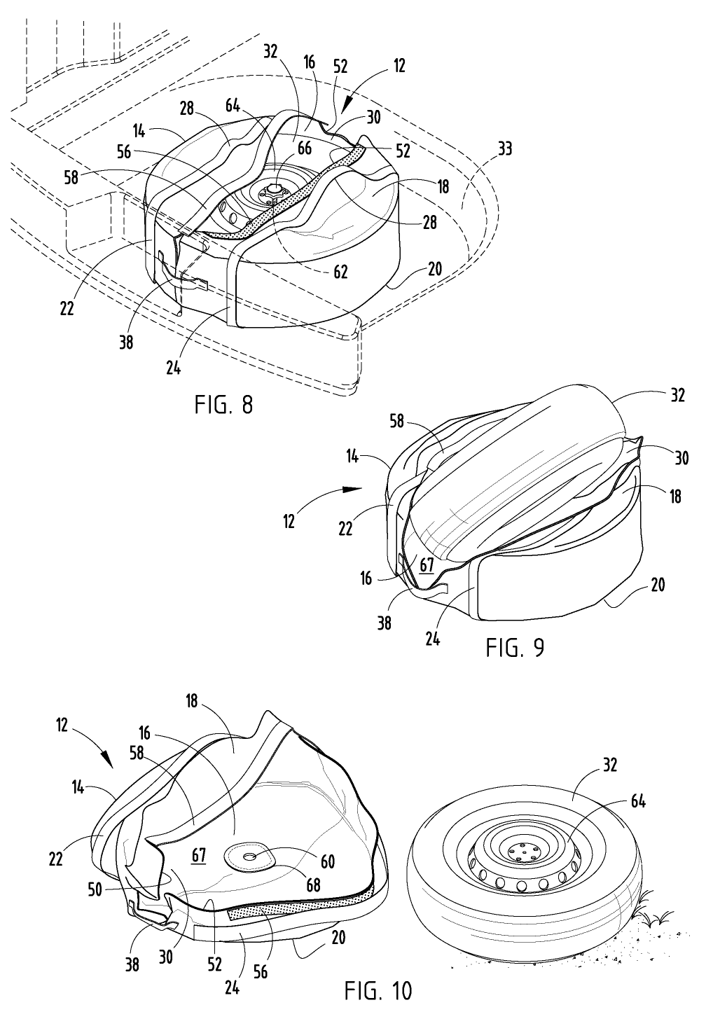

Referring now to FIGS. 8-10, the closable tire-receiving aperture 30 includes first and second aperture edges 50, 52 that are substantially parallel with one another and with the base portion 26 of the first and second straps 22, 24. It is contemplated that the first and second aperture edges 50, 52 may include a variety of closure mechanisms including a zipper closure mechanism 54 (FIG. 4) or a hook and loop fastener arrangement 56 (FIG. 8). The closable tire-receiving aperture 30 extends centrally across the entire top wall 18 of the flexible container 14, and further, may extend partially down a sidewall of the flexible container 14, or all the way to the bottom wall 20 of the flexible container 14 (FIG. 9). A protective flap 58 extends from the first aperture edge 50 and is designed to cover the first and second aperture edges 50, 52 when the tire-receiving aperture 30 is closed. It is also contemplated that the closable tire-receiving aperture 30 may be fixedly closed or even lockable.

Referring again to FIG. 10, the bottom wall 20 of the flexible container 14 includes a circular stud hole 60 adapted to receive a tire-securing stud 62. The tire-securing stud 62 extends upward from the spare tire well 33 into the flexible container 14 and through a rim 64 of the spare tire 32. The tire-securing stud 62 includes a hand-turnable securing knob 66 that secures the spare tire 32 to the vehicle 10. A reinforcing ring 68 is disposed around the stud hole 60 on an interior 67 of the flexible container 14. The reinforcing ring 68 protects the stud hole 60 from ripping and tearing, and also helps guide the tire-securing stud 62 into the stud hole 60.

Referring again to FIGS. 8-10, one method for removing the spare tire 32 from the trunk 31 includes placing the spare tire 32 in the flexible container 14, the flexible container 14 having the first and second circumferential lifting straps 22, 24 disposed thereon with the strap handle 28 oriented in an upward direction. Additionally, the closable tire-receiving aperture 30 would also be oriented in the upward direction. The flexible container 14 is placed and secured in the vehicle trunk 31 for emergency use. When the spare tire 32 is needed, the user would remove the securing knob 66 from the threaded tire-securing stud 62 after having first opened the closable tire-receiving aperture 30. The user would then withdraw the flexible container 14 from the spare tire well 33 by raising the lifting straps 22, 24. Once the flexible container 14 has been removed, the flexible container 14 can be placed on the ground and the spare tire 32 removed therefrom through the closable tire-receiving aperture 30.

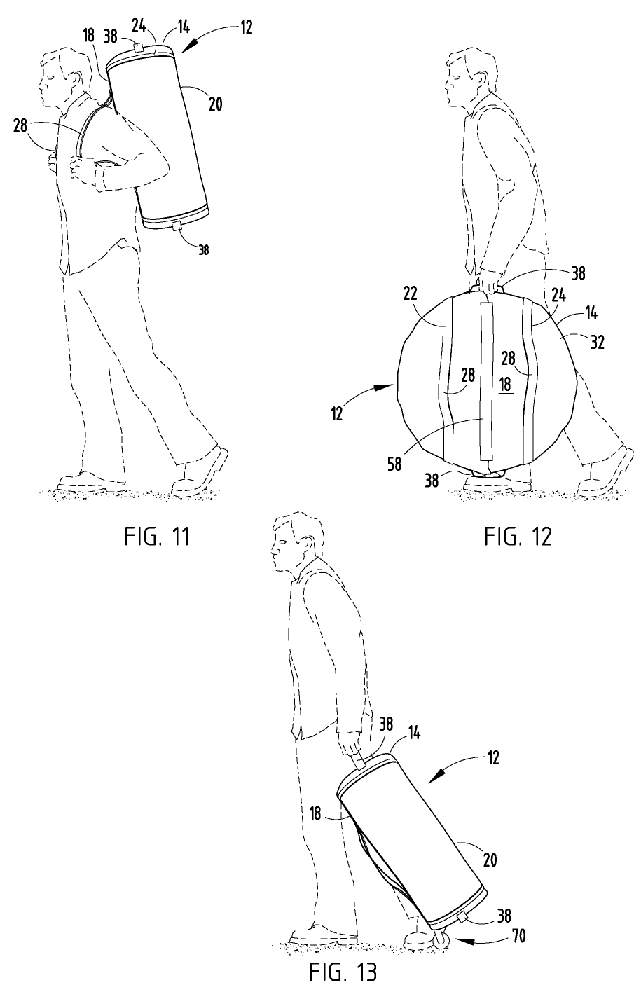

Referring now to the embodiment illustrated in FIGS. 11-13, the spare tire lift assist apparatus 12 can be mobilized in various ways. Specifically, the spare tire lift assist apparatus 12 can be carried in a backpack-type fashion by a user, as illustrated in FIG. 11. To wear the spare tire lift assist apparatus 12 in this manner, the user places one arm through each of the strap handles 28 with the back of the user in abutting contact with the spare tire lift assist apparatus 12. The spare tire 32 can then be transported as needed from one location to another location. The spare tire lift assist apparatus 12 can also be mobilized as illustrated in FIG. 12. Specifically, the user grasps one of the side handles 38 of the spare tire lift assist apparatus 12, lifts the spare tire lift assist apparatus 12 upwardly and moves the spare tire lift assist apparatus 12 to a desired location in a luggage-type fashion. Also, as shown in FIG. 13, the user can grasp a side handle 38 that is on an opposite side from a roller wheel assembly 70, tilt the spare tire lift assist apparatus 12, and move the spare tire lift assist apparatus 12 by rolling the roller wheel assembly 70 over a flat surface. It will be understood by one having ordinary skill in the art that the spare tire lift assist could be transported or mobilized in other various manners as well.

One method of making a spare tire lift assist apparatus includes forming a flexible container having a top wall and a bottom wall. At least one strap is connected to the bottom wall of the flexible container and a handle is formed proximate the top wall. The handle is formed from the at least one strap. An access aperture is formed in the spare tire lift assist apparatus and a tire is inserted into the access aperture.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A spare tire lift assist apparatus comprising:
a flexible container having a tire-receiving cavity, wherein the flexible container includes a top wall and a bottom wall;
first and second straps each including:
a base portion that extends around and is fastened to the bottom wall; and
a strap handle proximate the top wall; and
a closable tire-receiving aperture.

2. The spare tire lift assist apparatus of claim 1, wherein the closable tire-receiving aperture extends centrally across the entire top wall.

3. The spare tire lift assist apparatus of claim 1, wherein the tire-receiving aperture has defined aperture edges that are substantially parallel with the base portion of the first and second straps.

4. The spare tire lift assist apparatus of claim 1, wherein the straps include reflector portions.

5. The spare tire lift assist apparatus of claim 1, wherein the flexible container is made at least partially from one of polypropylene and nylon.

6. The spare tire lift assist apparatus of claim 1, wherein the closable tire-receiving aperture includes aperture edges with hook and loop fasteners.

7. The spare tire lift assist apparatus of claim 1, wherein the closable tire-receiving aperture includes aperture edges with a zipper closing mechanism.

8. The spare tire lift assist apparatus of claim 1, wherein the flexible container is formed from a plurality of interconnected support lines defining spaces therebetween.

9. A tire storage container comprising:
a smooth exterior having a top wall and a bottom wall, wherein the space between the top wall and the bottom wall defines a tire-receiving cavity;
at least one strap that includes a base portion that is fastened to the bottom wall and a handle that is proximate the top wall; and
a closable tire-receiving aperture that extends across the entire top wall.

10. The tire storage container of claim 9, wherein the closable tire-receiving aperture has defined aperture edges that are parallel with the base portion of the first and second straps.

11. The tire storage container of claim 9, further comprising:
a reflective portion with identifying indicia disposed thereon.

12. The tire storage container of claim 9, further comprising:
a storage pocket disposed on one of the top wall and the bottom wall.

13. The tire storage container of claim 9, further comprising:
a stud hole disposed in the bottom wall that is adapted to receive a tire-securing stud.

14. The tire storage container of claim 13, further comprising:
a reinforcing ring disposed around the stud hole.

15. A method for removing a spare tire from a vehicle trunk, the method comprising:
placing said spare tire in a flexible container having first and second circumferential lifting straps and a closable tire-receiving aperture;
placing the flexible container in a spare tire well disposed in said vehicle trunk;
withdrawing the flexible container from the spare tire well by raising the lifting straps; and
removing said spare tire from said closable tire-receiving aperture.

16. The method of claim 15, further comprising:
disconnecting an attachment feature disposed on the tire-receiving aperture before removing said spare tire.

17. A method for making a spare tire lift assist apparatus, the method comprising:
forming a flexible container having a top wall and a bottom wall;
connecting at least one strap to the bottom wall of the flexible container;
forming a handle proximate the top wall from the at least one strap;
forming an access aperture in said spare tire lift assist apparatus; and
inserting a tire into the access aperture.

18. The method of claim 17, further comprising:
forming an aperture in the bottom wall for receiving a tire-receiving stud.

19. The method of claim 17, further comprising:
forming a storage pocket on one of the top wall and the bottom wall.

20. The method of claim 17, further comprising:
forming a reflective portion with identifying indicia on the flexible container.
